(19) United States
(12) Patent Application Publication
(10) Pub. No.: US 2013/0253666 A1
(43) Pub. Date: Sep. 26, 2013

(54) AS-i APPARATUS

(71) Applicant: SIEMENS AKTIENGESELLSCHAFT, Munich (DE)

(72) Inventors: Markus PREMKE, Regensburg (DE); Jürgen WOLSKI, Vorra (DE)

(21) Appl. No.: 13/798,346

(22) Filed: Mar. 13, 2013

(30) Foreign Application Priority Data
Mar. 23, 2012 (EP) 12161023.2

(51) Int. Cl. G05B 15/02

(52) U.S. Cl. CPC G05B 15/02
USPC 700/9

(57) ABSTRACT

An apparatus for an AS-i system with a first AS-i master is disclosed. In at least one embodiment, the apparatus includes a first and a second terminal. Within the AS-i system is a second AS-i master for a downstream AS-i slave connected to the first terminal and is an AS-i slave for the first AS-i master connected to the second terminal. The apparatus is embodied such that it represents the downstream AS-i slave connected to it via the first terminal as an AS-i slave via the second terminal.

### PRIORITY STATEMENT

The present application hereby claims priority under 35 U.S.C. §119 to European patent application number EP 12161023 filed Mar. 23, 2012, the entire contents of which are hereby incorporated herein by reference.

### FIELD

At least one embodiment of the invention generally relates to an apparatus for an AS-i system with a first AS-i master.

### BACKGROUND

The AS-i system (AS-i=Actuator-Sensor interface) is an industrial field bus system at the lower level of control of an automation system, which connects a plurality of field device modules such as measurement probes (sensors), actuators and drives (actors), but also motor starters and frequency converters, to a higher-ranking control device. The AS-i system is thus a communication standard for communication between a master module connected to the control device (AS-i master) and AS-i slaves. Field device modules, which are connected to an AS-i slave, can thus be activated and/or read out via the AS-i master.

In a communications system embodied according to the AS interface specifications, the AS-i master sends a request cyclically to all AS-i slaves, to which the AS-i slaves respond. In this way the AS-i master exchanges data with the AS-i slaves via a transmission protocol with a defined payload data width. For this purpose each of the AS-i slaves is allocated a unique address. Within an AS-i system the number of available addresses for the AS-i slaves of an AS-i system is limited. The length of the AS-i system, i.e. the maximum length of an AS-i line between the AS-i master and the AS-i slave, is likewise limited.

### SUMMARY

At least one embodiment of the present invention is directed to improving the AS-i system. In particular, in at least one embodiment, the length of the AS-i system is to be enlarged.

An apparatus of at least one embodiment is for an AS-i system with a first AS-i master, wherein the apparatus has a first and a second terminal and, within the AS-i system, is a second AS-i master for a downstream AS-i slave connected to the first terminal and is an AS-i slave for the first AS-i master connected to the second terminal, wherein the apparatus is embodied such that it represents the AS-i slave connected downstream from it via the first terminal as an AS-i slave via the second terminal.

Advantageous developments of the invention are specified in the dependent claims 2 to 6.

### BRIEF DESCRIPTION OF THE DRAWINGS

The invention and embodiments of the invention will be described and explained below in greater detail on the basis of the exemplary embodiment presented in the figure.

FIG. 1 shows an AS-i system with a first AS-i master 4, a first AS-i power adapter 9, a first and second upstream AS-i slave 7, 8, an AS-i apparatus 3, a second AS-i power adapter 10 and a first and second downstream AS-i slave 5, 6. The AS-i apparatus 3 includes a first terminal 1, a second terminal 2 and a processing unit 13.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In at least one embodiment, a number of downstream AS-i slaves are connected to the apparatus via the first terminal, so that the apparatus is an AS-i master (second AS-i master) for all downstream AS-i slaves, which are connected to the first terminal. The apparatus preferably represents all downstream AS-i slaves connected via the first terminal as an AS-i slave via the second terminal. The respective downstream slaves are preferably each represented here as separate AS-i slaves for the first AS-i master via the second terminal.

The AS-i system thus comprises two AS-i masters, namely the first AS-i master and the apparatus as second AS-i master in respect of its first terminal. Within the AS-i system the apparatus, for the downstream AS-i slave(s) connected to it via the first terminal, completely maps the function of an AS-i master (as second AS-i master). The AS-i slave or slaves connected downstream communicate with the apparatus, as they usually communicate with an AS-i master. For the first AS-i master, to which the apparatus is connected via the second terminal, the apparatus itself is at least one AS-i slave and preferably represents the AS-i slave or slaves connected to it via the first terminal. The apparatus is thus in ongoing operation both an AS-i master (via the second terminal) and also at least one AS-i slave (via the first terminal). The assignment of the downstream AS-i slave(s) to the AS-i slave(s) emulated via the second terminal is stored in the apparatus. The communication between the apparatus and the downstream AS-i slave(s) and the first AS-i master occurs independently of one another; i.e. different AS-i addresses and/or communication channels can be used for communication purposes.

The use of at least one embodiment of the inventive apparatus enables the length of the AS-i system to be enlarged, especially doubled.

In an advantageous embodiment of the invention, the apparatus represents via the second terminal the respective downstream AS-i slave connected to it via the first terminal as a separate AS-i slave. The downstream AS-i slaves are preferably completely mapped/emulated as AS-i slaves during a communication cycle of the first (upstream) AS-i master by the apparatus itself. If e.g. seven AS-i slaves are connected to the first terminal, then the apparatus represents seven AS-i slaves via the second terminal for the first AS-i master, which are addressed/interrogated within a communication cycle of the AS-i master.

Preferably, in a first upstream communication cycle of the first AS-i master, the apparatus, representing the downstream AS-i slaves, is first supplied with payload data by the first AS-i master.

This payload data is received by the apparatus forwarded as the second AS-i master to the downstream AS-i slaves in a separate first downstream communication cycle (that of the second AS-i master). During the first downstream communication cycle of the second AS-i master the payload data of the downstream AS-i slaves is read in.

During a second upstream communication cycle of the first AS-i master the read-in payload data of the downstream AS-i slaves is output by the apparatus to the first AS-i masters.

For communication with the first AS-i master the apparatus preferably uses a separate AS-i address for each downstream AS-i slave. The AS-i address can be independent of the AS-i address used within downstream communication. The same applies to the communication channel used.

In an advantageous embodiment of the invention, the apparatus outputs payload data of a telegram of the downstream AS-i slaves arriving via the first terminal unchanged as AS-i slave via the second terminal. For communication between the apparatus (as AS-i slave) and the first AS-i master, the apparatus is not connected to the channel used for communication between the apparatus (as AS-i master) and the downstream AS-i slave and/or to the AS-i address. Communication between the apparatus and the downstream AS-i slave/the downstream AS-i slaves occurs independently from communication between the first AS-i master and the apparatus.

In an advantageous embodiment of the invention the apparatus outputs payload data of a telegram of the first AS-i master arriving via the second terminal unchanged as second AS-i master via the first terminal. The telegram is especially output to the downstream AS-i slave. For communication between it and the downstream AS-i slave the apparatus is not connected to the channel used and/or to the AS-i address used between the first AS-i master and the apparatus (as AS-i slave). Communication between the apparatus (as AS-i slave) and the AS-i master occurs independently from communication between the AS-i slave and the apparatus (as second AS-i master).

In a further advantageous embodiment of the invention the apparatus uses a different AS-i address and/or a different AS-i channel for communication with the AS-i slave to be represented than it does for communication with the first AS-i master in respect of the AS-i slaves to be represented.

In a further advantageous embodiment of the invention the AS-i system includes a first AS-i master, at least one downstream AS-i slave and the apparatus, wherein the apparatus is a second AS-i master for the at least one downstream AS-i slave connected to the first terminal and is an As-i slave for the first AS-i master connected to the second terminal, wherein the apparatus represents the at least one downstream AS-i slave connected to it as AS-i slave via the second terminal. The apparatus especially represents each downstream AS-i slave connected to the first terminal as an AS-i slave for the “upstream” first AS-i master via the second terminal.

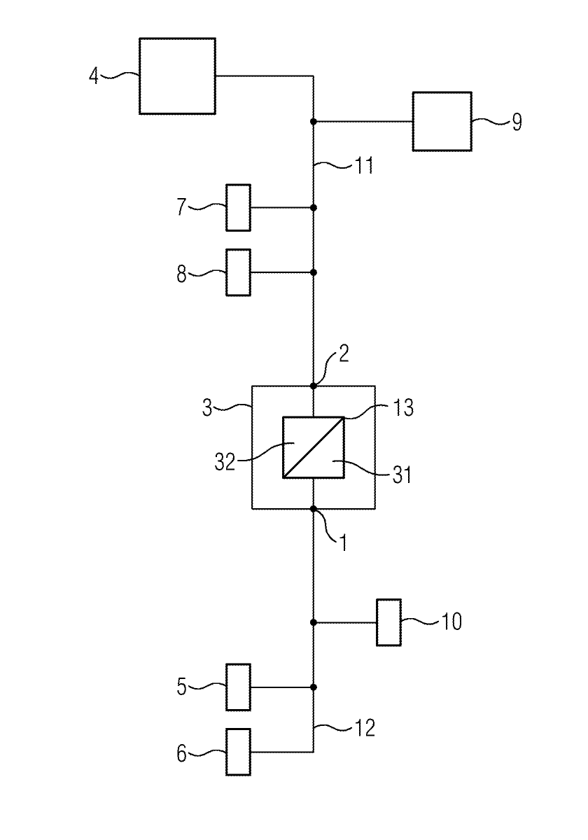

FIG. 1 shows an AS-i system with a first AS-i master 4, a first AS-i power adapter 9, a first and second upstream AS-i slave 7, 8, an AS-i apparatus 3, a second AS-i power adapter 10 and a first and second downstream AS-i slave 5, 6. The AS-i apparatus 3 includes a first terminal 1, a second terminal 2 and a processing unit 13.

The first AS-i master 4 is connected to the first power adapter 9, the first and second upstream AS-i slave 7, 8 and the second terminal 2 of the AS-i apparatus 3 by means of a first AS-i line 11. The AS-i apparatus 3 is connected via its first terminal 1 to the second power adapter 10 and the first and second downstream AS-i slave 5, 6 by means of a second AS-i line 12.

By using the AS-i apparatus 3 an upstream AS-i subsystem and a downstream AS-i subsystem are available, through which the AS-i system is formed. This enables the length of the overall AS-i system to be enlarged, especially doubled in length. In the upstream AS-i system the AS-i apparatus 3 is perceived by the first AS-i master 4 as an AS-i slave 32. This AS-i slave 32 can adopt a number of AS-i addresses, so that, for the first AS-i master 4, depending on the number of AS-i addresses adopted within a communication cycle of the first AS-i master 4, it can represent a number of AS-i slaves. The AS-i slave 32 is thus a slave emulator, which simultaneously, i.e. within one communication cycle, can represent a number of slaves to the first AS-i master 4.

In the downstream AS-i system the AS-i apparatus 3 is perceived by the first and second downstream AS-i slave 5, 6 as AS-i master 31 (second AS-i master). Since two downstream slaves 5, 6 are connected to the apparatus 3, the apparatus 3 represents via the upstream system for the first AS-i master 4 two AS-i slaves via the second terminal. The signals arriving at the first and second terminal 1, 2 are processed by the processing unit 13 of the AS-i apparatus 3. The processing unit 13 represents via the first terminal 1 the second AS-i master 31 and via the second terminal 2 the downstream AS-i slaves 5, 6 in each case as separate AS-i slaves 32 for the first AS-i master 4. The apparatus 3 thus claims two AS-i addresses in the upstream system as AS-i slave 32, via which it can be accessed by the first AS-i master 4. The processing unit 13 of the AS-i apparatus 3 takes over functions of an AS-i master via the first terminal 1 (second AS-i master 31) and via the second terminal 2 the function of at least one AS-i slave 32, in the present example embodiment functions of the first and second downstream AS-i slaves 5, 6.

The number of AS-i slaves to be represented via the second terminal 2 depends on the number of AS-i slaves 5, 6 connected to the apparatus at the first terminal. The apparatus 3, especially the processing unit 13, represents via its second terminal 2 as many AS-i slaves 32 as are connected to it via the first terminal 1. The number of slaves 32 represented via the second terminal 2 by the apparatus 3 thus corresponds to the number of downstream AS-i slaves 5, 6. For each downstream AS-i slave 5, 6 the apparatus, especially the processing unit 13, represents a specific AS-i address for the upstream system (the first AS-i master 4), so that the downstream AS-i slave 5, 6 can be represented via this AS-i address. Through the apparatus itself the downstream AS-i slaves 5, 6 are thus emulated and thereby represented via the second terminal.

In the present example embodiment, two AS-i slaves 5, 6 are connected to the apparatus 3 via the first terminal 1. The first and second downstream AS-i slave 5, 6 connected to the first terminal 1 see an AS-i master in the apparatus 3 (second AS-i master 31). For communication with the first AS-i master 4 the two downstream AS-i slaves 5, 6 are emulated by the processing unit 32 by the apparatus 3. Communication between the apparatus 3 and the first AS-i master 4 and the downstream AS-i slaves 5, 6 therefore takes place separately, so that independent AS-i addresses as well as communication channels (frequencies) can be used.

The apparatus 3 represents via the second terminal 2 the first downstream AS-i slave 5 with the AS-i address “x” and the second downstream AS-i slave 6 with the AS-i address “y”. In a first upstream communication cycle of the first AS-i master 4, the apparatus 3, representative of the downstream AS-i slaves 5, 6, is initially supplied via the AS-i address “x” and “y” with payload data from the first AS-i master 4.

This payload data is received by the apparatus 3 and forwarded as second AS-i master 31 to the downstream AS-i slaves 5, 6 in a separate first downstream communication cycle. Within the downstream system the first downstream AS-i slave 5 has the AS-i address “z” and the second downstream AS-i slave 6 has the AS-i address “x”. By means of the first downstream communication cycle the payload data received by the apparatus 3 as slave 32 with the address “x” is transmitted to the AS-i address “z” and thus to the first downstream slave 5. Within the same first downstream communication cycle the payload data received from the apparatus 3 as slave 32 with the address “y” is transmitted to the AS-i address “x” and thus to the second downstream slave 5. The issuing of the AS-i addresses in the upstream system (first master 4 - apparatus 3) can thus be undertaken independently of the issuing of the AS-i addresses in the downstream system (apparatus 3 - downstream AS-i slaves 5, 6). Likewise different communication channels can be used. By means of the first downstream communication cycle of the second AS-i master 31 the payload data of the downstream AS-i slaves 5, 6 is read in and assigned to the corresponding AS-i slave 32. The AS-i slave 32 represents via the AS-i address “x” and “y” the downstream AS-i slaves 5, 6 for the first AS-i master 4 and thus for the upstream AS-i system.

During a first upstream communication cycle of the first AS-i master 4 the input payload data of the downstream AS-i slaves 5, 6 is output by the apparatus 3 to the first AS-i master 4. For communication with the first AS-i master 4 the apparatus 3 uses the address “x” to transmit the received payload data of the first downstream slaves 5 and uses the address “y” to transmit the received payload data of the second downstream slave 6.

The AS-i address accepted by the apparatus 3 is thus independent of the AS-i address used within the downstream communication. Like the AS-i addresses, in addition or as an alternative different communication channels can be used independently from the upstream communication for downstream communication.

The assignment of the payload data received and sent via the first and second terminal 1, 2 is stored permanently in the processing unit 13 or can be planned into a project by a user. For communication with the downstream AS-i slaves 5, 6 the apparatus 3 is not connected to the AS-i address and/or to the communication channel of the communication between the apparatus 3 and the first AS-i master 4. The apparatus 3 preferably uses different addresses and/or communication channels for upstream and downstream communication in respect of the AS-i slave to be represented.

The communication channels, which are included in the downstream system, are thus channels used fully independently of the channels used in the upstream system. The extension of the AS-i system by the apparatus 3 is not known to the first master 4. It has only indirect access to the downstream AS-i slaves 5, 6 via the apparatus 3.

If for example 15 AS-i slaves were connected via the first terminal 1 to the apparatus 3, then the apparatus 3 would represent 15 AS-i slaves for the first AS-i master 4 via the second terminal 2. The processing unit 13 emulates 15 AS-i slaves 32 for the first AS-i master 4 with different AS-i addresses and communicates with the 15 downstream AS-i slaves as AS-i master 31.

The maximum possible number (nmax) of AS-i slaves to be represented and thus the number of AS-i slaves able to be connected to the first terminal 1 is dependent on the maximum possible number (mmax) of AS-i slaves which can be connected to the first AS-i master 4 and the number (z) of AS-i slaves 7, 8 connected to the first AS-i master 4 without taking into consideration the apparatus 3 itself. The maximum possible number nmax of AS-i slaves which is able to be connected to the first terminal 1 and is able to be represented via the second terminal 2 is defined as follows:

nₘₐₓ=mₘₐₓ−z

nₘₐₓ=Maximum possible number of AS-i slaves which is able to be connected to the first terminal 1 and is able to be represented via the second terminal 2.

mₘₐₓ=Maximum possible number of AS-i slaves which is able to be connected to the first AS-i master.

z=Number of AS-i slaves of the upstream system connected to the first AS-i master without taking into consideration the apparatus 3 itself.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims.

Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An apparatus for an AS-i system with a first AS-i master, the apparatus comprising:
a first and a second terminal, wherein within the AS-i system is a second AS-i master for a downstream AS-i slave connected to the first terminal and is an AS-i slave for the first AS-i master connected to the second terminal, and wherein the apparatus is embodied to represent the downstream AS-i slaves connected to the apparatus via the first terminal as an AS-i slave via the second terminal.

2. The apparatus of claim 1, wherein the apparatus represents via the second terminal, in each respective case, the down-stream AS-i slaves connected to the apparatus via the first terminal as a separate respective AS-i slave.

3. The apparatus of claim 1, wherein the apparatus outputs payload data of a telegram of the downstream AS-i slaves arriving via the first terminal unchanged via the second terminal as an AS-i slave.

4. The apparatus of claim 1, wherein the apparatus outputs payload data of a telegram of the first AS-i master arriving via the second terminal unchanged as second AS-i master via the first terminal.

5. The apparatus of claim 1, wherein the apparatus uses at least one of a different AS-i address and a different AS-i channel for communication with the AS-i slave to be represented, than the apparatus uses for communication with the first AS-i master.

6. An AS-i system comprising:
a first AS-i master;
at least one downstream AS-i slave; and
the apparatus of claim 1, wherein the apparatus is a second AS-i master for the at least one downstream AS-i slave connected to the first terminal and is an AS-i slave for the first AS-i master connected to the second terminal, and wherein the apparatus represents the at least one downstream AS-i slave connected to the apparatus via the first terminal as an AS-i slave via the second terminal.

7. The apparatus of claim 2, wherein the apparatus outputs payload data of a telegram of the downstream AS-i slaves arriving via the first terminal unchanged via the second terminal as an AS-i slave.

8. The apparatus of claim 2, wherein the apparatus outputs payload data of a telegram of the first AS-i master arriving via the second terminal unchanged as second AS-i master via the first terminal.

9. The apparatus of claim 2, wherein the apparatus uses at least one of a different AS-i address and a different AS-i channel for communication with the AS-i slave to be represented, than the apparatus uses for communication with the first AS-i master.

10. An AS-i system comprising:
a first AS-i master;
at least one downstream AS-i slave; and
the apparatus of claim 2, wherein the apparatus is a second AS-i master for the at least one downstream AS-i slave connected to the first terminal and is an AS-i slave for the first AS-i master connected to the second terminal, and wherein the apparatus represents the at least one downstream AS-i slave connected to the apparatus via the first terminal as an AS-i slave via the second terminal.
